(19) United States
(12) Patent Application Publication
(10) Pub. No.: US 2020/0400436 A1
(43) Pub. Date: Dec. 24, 2020

(54) INFORMATION PROCESSING DEVICE, INFORMATION PROCESSING METHOD, AND PROGRAM

(71) Applicant: SONY CORPORATION, TOKYO (JP)

(72) Inventors: MASATO KIMISHIMA, TOKYO (JP); YOSHITAKA SUGA, KANAGAWA (JP)

(21) Appl. No.: 16/959,187

(22) PCT Filed: Oct. 17, 2018
(86) PCT No.: PCT/JP2018/038719

§ 371 Date: Jun. 30, 2020

(30) Foreign Application Priority Data
Jan. 9, 2018 (JP) 2018-001176

(51) Int. Cl. G01C 21/16; G06F 3/01; G01P 15/08

(52) U.S. Cl. CPC G01C 21/16; G01P 15/08; G06F 3/011; G06F 3/017

(57) ABSTRACT

[Problem] To enable implementation of flexible and highly accurate function control according to the properties of each of a plurality of sensors. [Solution] An information processing device is provided which includes an evaluation unit that, based on sensor information coming from a plurality of inertial sensors, performs relative evaluation of the sensor properties of the inertial sensors; and a control unit that, based on evaluation information generated by the evaluating unit, performs dynamic control related to the input-output of the sensor information. Moreover, an information processing method is provided that is implemented in a processor and that includes performing relative evaluation of the sensor properties of a plurality of inertial sensors based on sensor information coming from the inertial sensors; and performing dynamic control related to the input-output of the sensor information based on evaluation information that is generated.

### FIELD

The application concerned is related to an information processing device, an information processing method, and a program.

### BACKGROUND

In recent years, devices and applications in which acceleration information and angular velocity information obtained by inertial sensors is used are widely prevalent. For example, in Patent Literature 1, an electronic device is disclosed in which a plurality of inertial sensor elements is arranged.

### CITATION LIST

### Patent Literature

Patent Literature 1: JP 2008-224229 A

### SUMMARY

### Technical Problem

However, as disclosed in Patent Literature 1, when a plurality of inertial sensor elements is arranged, it is believed that the inertial sensor elements have individual differences in their properties. For that reason, by obtaining the output value that takes into account the individual differences, it is expected to achieve the effect of enhancing the accuracy of the functions in which the output value is used.

In that regard, in the application concerned, an information processing device, an information processing method, and a program in a new and improved form are proposed that enable implementation of flexible and highly accurate function control according to the properties of each of a plurality of sensors.

### Solution to Problem

According to the present disclosure, an information processing device is provided that includes: an evaluation unit that, based on sensor information coming from a plurality of inertial sensors, performs relative evaluation of sensor property of the plurality of inertial sensors; and a control unit that, based on evaluation information generated by the evaluating unit, performs dynamic control related to input-output of the sensor information.

Moreover, according to the present disclosure, an information processing method implemented in a processor is provided that includes: evaluating that, based on sensor information coming from a plurality of inertial sensors, includes performing relative evaluation of sensor property of the plurality of inertial sensors; and controlling that, based on generated evaluation information, includes performing dynamic control related to input-output of the sensor information.

Moreover, according to the present disclosure, a program is provided that causes a computer to function as an information processing device including an evaluation unit that, based on sensor information coming from a plurality of inertial sensors, performs relative evaluation of sensor property of the plurality of inertial sensors, and a control unit that, based on evaluation information generated by the evaluating unit, performs dynamic control related to input-output of the sensor information.

### Advantageous Effects of Invention

As described above, according to the application concerned, it becomes possible to implement flexible and highly accurate function control according to the properties of each of a plurality of sensors.

The abovementioned effect is not necessarily limited in scope and, in place of or in addition to the abovementioned effect, any other effect indicated in the present written description or any other effect that may occur from the present written description can also be achieved.

### BRIEF DESCRIPTION OF DRAWINGS

FIG. 1 is a block diagram illustrating a configuration example of an information processing system according to an embodiment of the application concerned.

FIG. 2 is a block diagram illustrating a functional configuration example of an information processing terminal according to the embodiment.

FIG. 3 is a block diagram illustrating a functional configuration example of an information processing server according to the embodiment.

FIG. 4 is a diagram for explaining an example of performing relative evaluation according to the embodiment.

FIG. 5 is a diagram for explaining divergence-based evaluation according to the embodiment.

FIG. 6 is a diagram for explaining the relative evaluation performed with respect to a combination of a plurality of inertial sensors according to the embodiment.

FIG. 7 is a flowchart for explaining a flow of operations for deciding on the priority according to the embodiment.

FIG. 8 is a diagram for explaining the scale factor related to a gyro sensor according to the embodiment.

FIG. 9 is a diagram for explaining the scale factor related to an acceleration sensor according to the embodiment.

FIG. 10 is a diagram for explaining the relative evaluation of the scale factor according to the embodiment.

FIG. 11 is a diagram for explaining the axial alignment of an inertial sensor according to the embodiment.

FIG. 12 is a diagram for explaining the relative evaluation of axial alignment according to the embodiment.

FIG. 13 is a diagram for explaining the habitual route according to the embodiment.

In FIG. 14 is illustrated an example of the habitual route that is based on a plurality of PDR loci according to the embodiment.

FIG. 15 is a diagram for explaining the evaluation information for each three-axis attitude according to the embodiment.

FIG. 16 is a diagram illustrating an example of application control performed based on the evaluation of each three-axis attitude according to the embodiment.

FIG. 17 is a diagram for explaining the arrangement control of the inertial sensors according to the embodiment.

FIG. 18 is a diagram for explaining the bias compensation performed based on the habitual route according to the embodiment.

FIG. 19 is a diagram for explaining about obtaining the habitual route based on the user input according to the embodiment.

FIG. 20 is a diagram for explaining the selection of inertial sensors based on the reference performance according to the embodiment.

FIG. 21 is a diagram for explaining the selection of inertial sensors based on the reference performance according to the embodiment.

FIG. 22 is a diagram for explaining the selection of inertial sensors based on the reference performance according to the embodiment.

FIG. 23 is a diagram for explaining the multidirectional arrangement of the inertial sensors according to the embodiment.

FIG. 24 is a diagram for explaining the remote control performed with respect to the inertial sensors installed in an artificial satellite according to the embodiment.

FIG. 25 is a diagram illustrating a hardware configuration example according to the embodiment of the application concerned.

### DESCRIPTION OF EMBODIMENTS

A preferred embodiment of the application concerned is described below in detail with reference to the accompanying drawings. In the present written description and the drawings, the constituent elements having practically identical functional configuration are referred to by the same reference numerals, and the explanation is not given repeatedly.

The explanation is given in the following sequence.
1. Embodiment
   1.1. Overview
   1.2. System configuration example
   1.3. Functional configuration example of information processing terminal 10
   1.4. Functional configuration example of information processing server 20
   1.5. Details of evaluation and control
2. Hardware configuration example
3. Summary

### 1. Embodiment

«1.1. Overview»

Firstly, the explanation is given about the overview of the example of the application concerned. As described above, in recent years, various technologies are being developed in which inertial sensors are used. Examples of the technologies using inertial sensors also include technologies such as the pedestrian dead reckoning (PDR) and the inertial navigation system (INS) that are related in obtaining the movement locus.

According to the technology such as the PDR or the INS, for example, even in a place or a situation in which it is difficult to use the GNSS (Global Navigation Satellite System), the movement locus of the concerned device can be obtained and used in various use applications.

Moreover, in order to enhance the accuracy in obtaining the movement locus using the PDR or the INS, for example, it is possible to think of a method in which a plurality of inertial sensor elements (hereinafter, simply called inertial sensors) is arranged as disclosed in Patent Literature 1, and the sensor information collected by each inertial sensor is synthesized.

According to that method, it is possible to absorb the sensor properties including the bias of each inertial sensor, and to reduce the error factors. However, for example, if inertial sensors having excellent performance (i.e., having low bias instability) and inertial sensors having poor performance (i.e., having high bias instability) are synthesized while putting the same emphasis thereon, then it is believed that deterioration occurs in the error reduction effect and the error conversely becomes larger.

Hence, in order to enhance the error reduction effect, it is desirable that the synthesis-related emphasis is varied according to the sensor properties of each inertial sensor. However, the sensor properties such as the bias characteristics undergo dynamic fluctuation in a short period of time. Hence, even if the sensor properties of each inertial sensor are measured before the shipment of the manufactured product and the synthesis-related emphasis is decided according to those sensor properties, it is highly likely that the decided emphasis does not produce the effect at the time of use of that manufactured product by the user.

In view of the reasons given above, in order to enhance or maintain the accuracy of the functions that make use of the inertial sensors, it becomes necessary to dynamically measure the fluctuating sensor properties of a plurality of inertial sensors, and to perform the synthesis according to the sensor properties.

Herein, as a method for measuring the sensor properties of the inertial sensors, for example, it is possible to think of using high-accuracy reference information. As a result of using high-accuracy reference information, it becomes possible to obtain the absolute values related to the sensor properties of the inertial sensors, and to decide on the synthesis-related emphasis of the sensor information in a precise manner.

Examples of high-accuracy reference information include measurement of the gyro bias while the device is out of operation. If a device including inertial sensors is kept out of operation for a long period of time (for example, 50 minutes) and then the gyro data is obtained, then the angular velocity of zero is obtained as the reference when the device is out of operation. Thus, based on that reference, the bias of the inertial sensors can be estimated with high accuracy. However, in the method given above, not only the other type of sensor information becomes redundant, it also becomes difficult to keep track of fluctuations in the sensor properties when the device is in operation.

As another example of high-accuracy reference information, it is possible to think of GNSS signals. In the case of using GNSS signals as the reference, high-accuracy three-dimensional velocity can be obtained in an excellent reception environment such as outdoors, and the gyro bias having high accuracy can be measured. However, if the azimuth and the attitude are varied at the same location without any movement, then it is not possible to obtain the azimuth information. Moreover, for example, at a location such as indoors where the received signal strength is weak, it is difficult to use the azimuth information as the reference.

For example, as the reference for attitude variation and velocity, it is also possible to think of using the data obtained according to the Visual SLAM (Simultaneous Localization and Mapping) technology. However, in the case of a dark place or a distant view, or when a dynamic body is included in the photographic subjects, the accuracy undergoes a decline thereby making it difficult to use the information as the reference.

Meanwhile, geomagnetism information can also be used as the reference. However, geomagnetism information is significantly affected by magnetic disturbances or magnetic polarization attributed to, for example, reinforcing steel or electrical wires. Hence, except for the locations that are determined in advance to be less affected by such factors, it is difficult to use the geomagnetism information as the reference.

The technical idea according to the application concerned is conceptualized as a result of focusing on such issues, and enables implementation of flexible and highly accurate function control according to the properties of each of a plurality of sensors. In order to achieve that, an information processing device that implements an information processing method according to the present embodiment includes an evaluating unit that, based on sensor information coming from a plurality of inertial sensors, performs relative evaluation of the sensor properties of a plurality of sensors; and includes a control unit that, based on evaluation information generated by the evaluating unit, performs dynamic control related to the input-output of the sensor information.

That is, in the information processing device according to the present embodiment, even when high-accuracy reference cannot be obtained, the sensor properties of a plurality of sensors can be obtained as the relative differences among the sensors, and high-accuracy input-output control can be performed according to the relative differences. Given below is the detailed explanation about the features of the information processing device according to the present embodiment and about the effects produced due to those features.

«1.2. System Configuration Example»

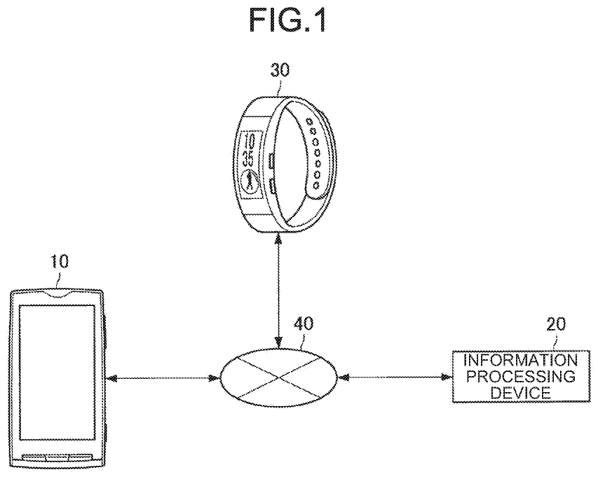

Firstly, given below is a configuration example of the information processing system according the embodiment of the application concerned. FIG. 1 is a block diagram illustrating a configuration example of the information processing system according to the embodiment of the application concerned. With reference to FIG. 1, the information processing system according to the present embodiment includes an information processing terminal 10, an information processing server 20, and a sensor terminal 30. The constituent elements are connected to each other in a communicable manner via a network 40.

(Information Processing Terminal 10)

The information processing terminal 10 according to the present embodiment is an information processing device that includes a plurality of inertial sensors and that provides the user with the functions according to the collected sensor information. The information processing terminal 10 according to the present embodiment can perform operations based on the control performed by the information processing server 20. The information processing terminal 10 according to the present embodiment can be, for example, one of various types of wearable terminals such as a cellular phone, a smartphone, or a tablet.

Moreover, the information processing terminal 10 according to the present embodiment aggregates the sensor information collected by the sensor terminal 30, and can send the aggregated sensor information to the information processing server 20.

(Information Processing Server 20)

The information processing server 20 according to the present embodiment is an information processing device that evaluates the sensor properties of a plurality of inertial sensors based on the sensor information collected by the information processing terminal 10 and the sensor terminal 30; and, based on the evaluation, dynamically performs control related to the input-output of the sensor information. The sensor properties according to the present embodiment include the bias characteristics, the scale factor, and the axial alignment.

(Sensor Terminal 30)

The sensor terminal 30 is an information processing device that includes a plurality of inertial sensors. The sensor information collected by the sensor terminal 30 is, for example, sent to the information processing server 20 via the information processing terminal 10. The sensor terminal 30 according to the present embodiment can be, for example, a wearable terminal such as a wristband-type terminal.

(Network 40)

The network 40 has the function of connecting the constituent elements of the information processing system to each other. The network 40 can be a public network such as the Internet, a telephone network, or a satellite communication network; or can be one of various types of LAN (Local Area Network) such as the Ethernet (registered trademark); or can be a WAN (Wide Area Network). Alternatively, the network 40 can be a leased line network such as IP-VPN (Internet Protocol-Virtual Private Network). Still alternatively, the network 40 can be a wireless communication network such as Wi-Fi (registered trademark) or Bluetooth (registered trademark).

Till now, the explanation was given about a configuration example of the information processing system according to the embodiment of the application concerned. The configuration explained above with reference to FIG. 1 is only exemplary, and the information processing system according to the present embodiment is not limited to have that configuration. For example, the information processing system according to the present embodiment need not always include the sensor terminal 30. Moreover, the functions of the information processing server 20 can be implemented as the functions of the information processing terminal 10. Thus, the configuration of the information processing system according to the present embodiment can be flexibly modified according to specifications and operations.

«1.3. Functional Configuration Example of Information Processing Terminal 10»

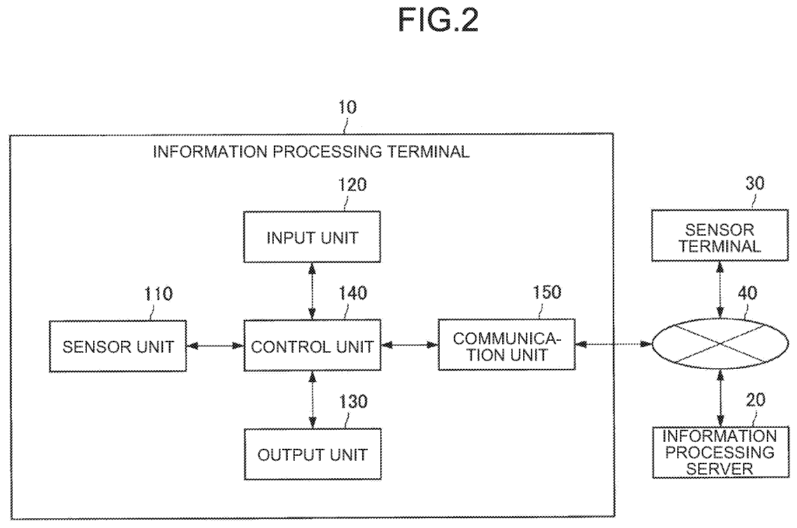

Given below is the explanation of a functional configuration example of the information processing terminal 10 according to the embodiment of the application concerned. FIG. 2 is a block diagram illustrating a functional configuration example of the information processing terminal 10 according to the present embodiment. With reference to FIG. 2, the information processing terminal 10 according to the present embodiment includes a sensor unit 110, an input unit 120, an output unit 130, a control unit 140, and a communication unit 150.

(Sensor Unit 110)

The sensor unit 110 according to the present embodiment includes a plurality of inertial sensors, and collects sensor information such as acceleration information and angular velocity information. Moreover, the sensor unit 110 can perform operations such as analog-to-digital conversion and noise removal with respect to the collected data. Furthermore, the sensor unit 110 according to the present embodiment can include a GNSS signal receiver and an imaging device.

(Input Unit 120)

The input unit 120 according to the present embodiment detects input operations performed by the user. For that reason, the input unit 120 according to the present embodiment includes, for example, a keyboard, a touch-sensitive panel, and various buttons.

(Output Unit 130)

The output unit 130 according to the present embodiment has the function of providing a variety of information to the user based on the control performed by the control unit 140 and the information processing server 20. Hence, the output unit 130 according to the present embodiment includes one of various types of display devices, an amplifier, and a speaker.

(Control Unit 140)

The control unit 140 according to the present embodiment has the function of comprehensively controlling the constituting elements of the information processing terminal 10. For example, the control unit 140 can control the activation and deactivation of the constituent elements. Moreover, the control unit 140 has the function of handing over various control signals, which are generated by the information processing server 20, to the constituent elements. Moreover, the control unit 140 according to the present embodiment can also have the functions equivalent to a control unit 220 of the information processing server 20 (described later).

(Communication Unit 150)

The communication unit 150 according to the present embodiment communicates information with the information processing server 20 and the sensor terminal 30 via the network 40. For example, the communication unit 150 can send the sensor information, which is collected by the sensor unit 110, to the information processing server 20; and can receive various control signals generated by the information processing server 20.

Till now, the explanation was given about a functional configuration example of the information processing terminal 10 according to the embodiment of the application concerned. The configuration explained with reference to FIG. 2 is only exemplary, and the information processing terminal 10 according to the present embodiment is not limited to have that functional configuration. For example, the control unit 140 of the information processing terminal 10 can have the functions equivalent to the control unit 220 of the information processing server 20. Thus, the functional configuration of the information processing terminal 10 according to the present embodiment can be flexibly modified according to specifications and operations.

«1.4. Functional Configuration Example of Information Processing Server 20»

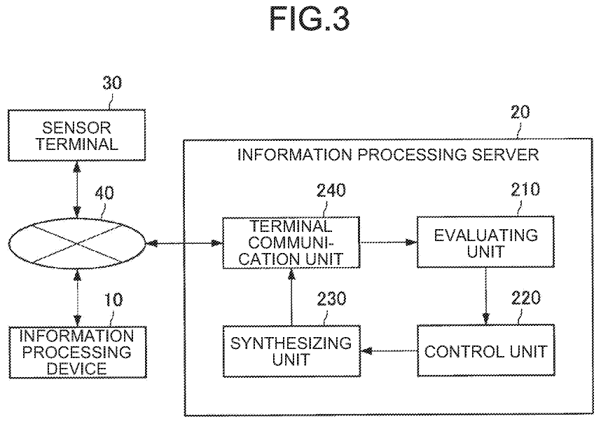

Given below is the explanation of a functional configuration example of the information processing server 20 according to the present embodiment. FIG. 3 is a block diagram illustrating a functional configuration example of the information processing server 20 according to the present embodiment. With reference to FIG. 3, the information processing server 20 according to the present embodiment includes an evaluating unit 210, the control unit 220, a synthesizing unit 230, and a terminal communication unit 240.

(Evaluating Unit 210)

The evaluating unit according to the present embodiment has the function of performing relative evaluation of the sensor properties of a plurality of inertial sensors, which are included in the information processing terminal 10 or the sensor terminal 30, based on the sensor information coming from the inertial sensors. Examples of the sensor properties of the inertial sensors include the gyro bias characteristics (hereinafter, also simply referred to as the bias characteristics), the G-Sensitivity characteristics, the scale factor, and the axial alignment. Regarding the functions of the evaluating unit 210 according to the present embodiment, the detailed explanation is separately given later.

(Control Unit 220)

The control unit 220 according to the present embodiment has the function of dynamically performing control related to the input-output of the sensor information based on the evaluation information generated by the evaluating unit 210. For example, based on the evaluation information, the control unit 220 according to the present embodiment can also control the synthesis operation performed by the synthesizing unit 230 for synthesizing the sensor information. Moreover, the control unit 220 can control the activation and deactivation of the inertial sensors included in the information processing terminal 10 or the sensor terminal 30. Furthermore, the control unit 220 can control various applications in which the synthesized sensor information is used. Regarding the functions of the control unit 220 according to the present embodiment, the detailed explanation is separately given later.

(Synthesizing Unit 230)

The synthesizing unit 230 according to the present embodiment has the function of synthesizing the sensor information, which comes from a plurality of inertial sensors, based on the control performed by the control unit 220. Meanwhile, the synthesizing unit 230 according to the present embodiment can alternatively be implemented as a function of the information processing terminal 10.

(Terminal Communication Unit 240)

The terminal communication unit 240 according to the present embodiment communicates information with the information processing terminal 10 and the sensor terminal 30 via the network 40. For example, the terminal communication unit 240 receives the sensor information collected by the information processing terminal 10, and sends the various control signals generated by the control unit 220 and the sensor information synthesized by the synthesizing unit 230 to the information processing terminal 10. As described above, the control signals include control signals related to the applications in which the sensor information is used, and control signals related to the activation and deactivation of the inertial sensors.

Till now, the explanation was given about a functional configuration example of the information processing server 20 according to the embodiment of the application concerned. The configuration explained with reference to FIG. 3 is only exemplary, and the information processing server 20 according to the present embodiment is not limited to have that configuration. For example, the configuration explained with reference to FIG. 3 can be implemented among a plurality of devices in a dispersed manner. Moreover, the functions of the information processing device 20 can be implemented as the functions of the information processing terminal 10. Thus, the functional configuration of the information processing server 20 according to the present embodiment can be flexibly modified according to specifications and operations.

«Details about Evaluation and Control»

Given below is the detailed explanation about the evaluation of a plurality of inertial sensors performed by the information processing server 20 according to the present embodiment, and about the control performed based on that evaluation. The following explanation is given mainly for an example in which relative evaluation of the bias characteristics of a plurality of inertial sensors, which are included in the information processing terminal 10 being carried by the user, is performed based on the sensor information obtained by the inertial sensors.

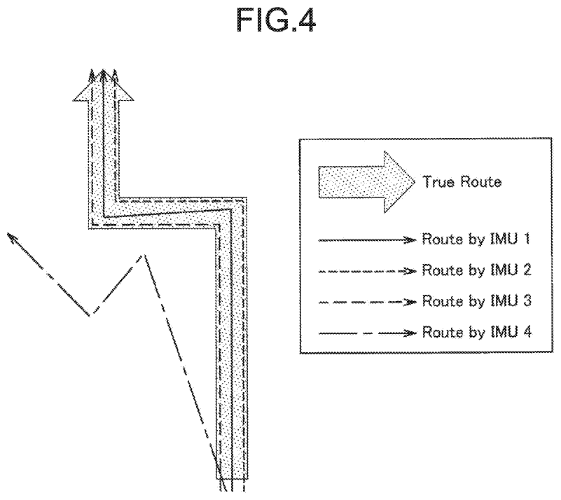

FIG. 4 is a diagram for explaining an example of performing relative evaluation according to the present embodiment. For example, as illustrated in FIG. 4, the evaluating unit 210 according to the present embodiment can calculate the attitude based on the sensor information obtained by each inertial sensor, and can calculate the PDR locus. In FIG. 4, the true route actually walked by the user is illustrated along with four other routes calculated from the sensor information collected by inertial sensors 1 to 4 included in the information processing terminal 10.

As a result of comparing the four routes, it can be understood that only the route attributed to the inertial sensor 4 has significantly deviated from the other three routes. Thus, the evaluating unit 210 according to the present embodiment can evaluate that, as compared to the inertial sensors 1 to 3, the inertial sensor 4 has poor bias characteristics (has a high bias instability). In that case, the control unit 220 can set a low synthesizing emphasis for the sensor information collected by the inertial sensor 4, and can thus obtain the PDR locus having high accuracy. Meanwhile, the control unit 220 can apply that emphasis in a retrospective manner too.

In this way, as a result of using the information processing server 20 according to the present embodiment, no high-accuracy reference is required; and it becomes possible to perform relative evaluation of the bias characteristics of a plurality of inertial sensors, and to perform the synthesis operation with high accuracy.

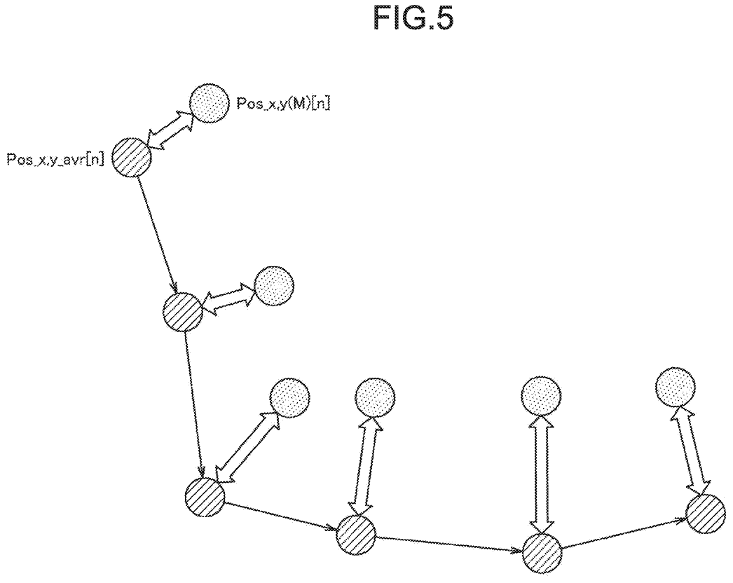

The evaluating unit 210 according to the present embodiment can perform the evaluation based on, for example, the divergence between the weighted average of the sensor information attributed to a plurality of inertial sensors and the sensor information attributed to the target inertial sensor for evaluation. FIG. 5 is a diagram for explaining the evaluation performed based on the divergence according to the present embodiment.

In FIG. 5, Pos_x, y_avr[n] represents the average PDR locus of all inertial sensors, and Pos_x, y(M)[n] represents the PDR locus of an inertial sensor M that is the evaluation target. Herein, “n” represents the number (timing) of the position in chronological order.

Herein, divergence Error (M) represents the means square error of the PDR locus of the target inertial sensor M for evaluation and the average PDR locus of all inertial sensors, and can be expressed using Equation (1) given below. In Equation (1), N represents the total number of positions. Moreover, as illustrated in Equation (2) given below, the reciprocal of the divergence is defined as a ratio Wait (M) of the weighted average of each inertial sensor. Then, at a timing k arriving after the timing n, as given below in Equations (3) and (4), positions Pos_fused_x, y are calculated by taking the weighted average at the ratio Wait (M).

$$\begin{matrix}Error ( M ) = {\sum }_{n} ( {( Pos\_x ( M ) [ n ] - Pos\_x \_avr [ n ] )}^{2} ) + {( Pos\_y ( M ) [ n ] - Pos\_y \_avr [ n ] )}^{2} & ( 1 ) \\ Wait ( M ) = 1 \text{/} Error ( M ) \text{/} {\sum }_{M} ( 1 \text{/} Error ( M ) ) & ( 2 ) \\ Pos\_fused \_x [ k ] = {\sum }_{M} ( Wait ( M ) * Pos\_x ( M ) [ k ] ) & ( 3 ) \\ Pos\_fused \_y [ k ] = {\sum }_{M} ( Wait ( M ) * Pos\_y ( M ) [ k ] ) & ( 4 )\end{matrix}$$

In this way, as a result of using the evaluating unit 210 according to the present embodiment, by obtaining the divergence, evaluation information can be generated in regard to the relative evaluation of the bias characteristics of the inertial sensors. Thus, because of the functions of the evaluating unit 210, the control unit 220 can decide on the synthesizing emphasis for each inertial sensor based on the divergence, and can obtain the PDR locus having high accuracy.

Meanwhile, for example, if the divergence is greater than a threshold value (for example, 100 m²), then the control unit 220 can perform control to not use the sensor information collected by the concerned inertial sensor in the synthesis, or can perform control to switch off the power supply of that inertial sensor. Thus, by excluding the inertial sensors having drastically low accuracy, the overall accuracy can be enhanced as well as the processing cost and power consumption can be reduced.

The explanation above was given about the case in which the evaluating unit 210 individually compares the PDR locus of each inertial sensor. Alternatively, the evaluating unit 210 according to the present embodiment can perform PDR locus comparison corresponding to combinations of a plurality of inertial sensors, and can perform relative evaluation of the bias characteristics of each inertial sensor.

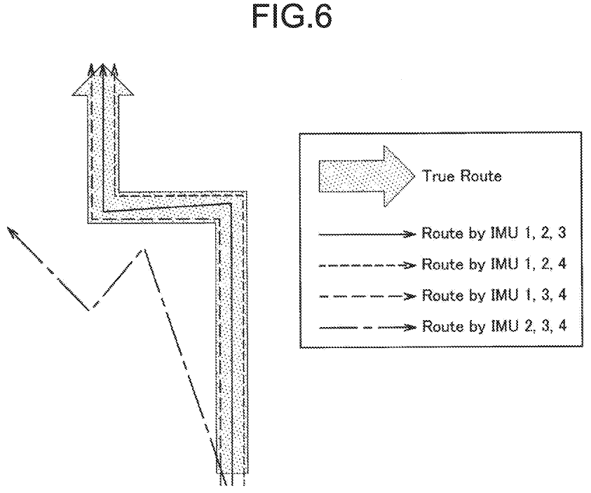

FIG. 6 is a diagram for explaining the relative evaluation performed with respect to combinations of a plurality of inertial sensors according to the present embodiment. In FIG. 6, the true route actually walked by the user is illustrated along with four other routes each obtained by combining three of the four inertial sensors 1 to 4. If the four routes are compared, only the route obtained by combining the inertial sensors 2 to 4 has significantly deviated from the other three routes. Thus, the evaluating unit 210 according to the present embodiment can evaluate that, as compared to the inertial sensors 2 to 4, the inertial sensor 1 has excellent bias characteristics (has a low bias instability).

In this way, as a result of comparing the information obtained by combining a plurality of sensors, the evaluating unit 210 according to the present embodiment becomes able to identify the inertial sensor having relatively excellent properties. Moreover, by performing the comparison operation in a repeated manner, the evaluating unit 210 according to the present embodiment can sequentially identify the inertial sensors having excellent properties and accordingly set the priority for a plurality of inertial sensors.

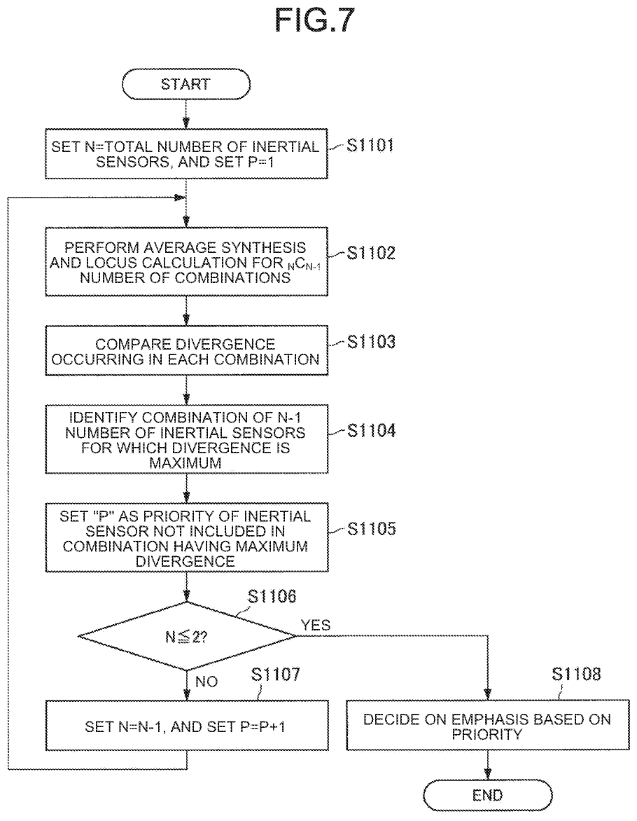

FIG. 7 is a flowchart for explaining a flow of operations for deciding on the priority according to the present embodiment. With reference to FIG. 7, the evaluating unit 210 sets a variable N to the total number of inertial sensors to be evaluated, and sets a variable P to “1” (S1101). The variable P can be a variable for storing the priority.

Then, the evaluating unit performs average synthesis and locus calculation for the _{N}C_{N-1} number of combinations (S1102).

Subsequently, the evaluating unit 210 calculates the divergence occurring in each combination, and compares the divergences (S1103).

Then, the evaluating unit 210 identifies such a combination of N−1 number of inertial sensors for which the divergence is the maximum (S1104).

Subsequently, the evaluating unit 210 sets “P” as the priority of the inertial sensor that is not included in the combination of N−1 number of inertial sensors as identified at S1104 (S1105).

Then, the evaluating unit 210 determines whether or not the value of the variable N is equal to or smaller than two (S1106).

If the value of the variable N is equal to or greater than three (No at S1106), then the evaluating unit sets “N−1” in the variable N and sets “P+1” in the variable P (S1107), and the system control returns to S1102.

On the other hand, if the value of the variable N is equal to or smaller than two (Yes at S1106), that is, if the comparison of the last two inertial sensors is completed, then the control unit 220 decides on the synthesizing emphasis based on the set priority and makes the synthesizing unit 230 perform the synthesis operation based on that emphasis (S1108).

Given below is Table 1 representing an example of the evaluation information related to the priority and generated as a result of the operations described above. In Table 1, smaller the numerical value, the higher is the priority. Moreover, the priority values can indicate the priority order of a plurality of inertial sensors.

TABLE 1

| Inertial sensor # | 1 | 2 | 3 | 4 |
|---|---|---|---|---|
| Priority | 3 | 1 | 2 | 4 |

In this way, the evaluating unit 210 according to the present embodiment generates the evaluation information containing the priority of a plurality of inertial sensors, and the control unit 220 can dynamically decide on the synthesizing emphasis for each inertial sensor.

Meanwhile, the flowchart explained with reference to FIG. 7 is only exemplary, and the flow of operations for deciding on the priority according to the present embodiment is not limited to that example. For example, the variable P is not always required, and can be substituted with the variable N. In that case, the higher numerical value can be assumed to have the higher priority and the operations can be accordingly performed.

Till now, the explanation was given about the example in which the evaluating unit 210 performs relative evaluation of the bias characteristics of each inertial sensor. However, the sensor properties according to the present embodiment are not limited to that example. Alternatively, for example, the evaluating unit 210 can perform relative evaluation of the scale factor (also called the gain or the sensitivity) of each inertial sensor.

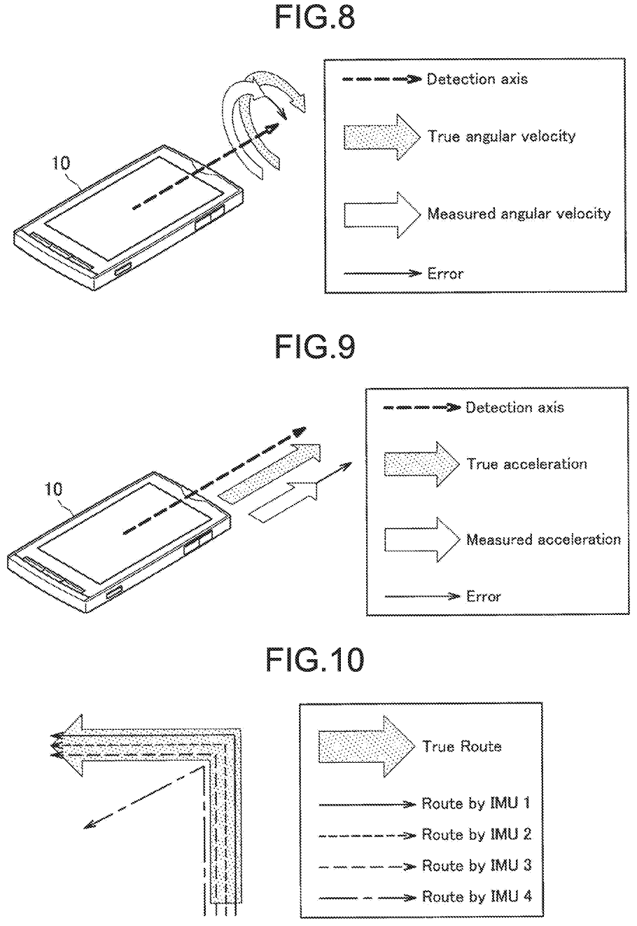

Herein, firstly, the explanation is given about the scale factor. FIG. 8 is a diagram for explaining the scale factor related to a gyro sensor. The scale factor related to a gyro sensor represents the property which, under the premise that the other sensor properties such as the bias characteristics are ideal, indicates the ratio of the true angular velocity with respect to the measured angular velocity around the detection axis. That is, the scale factor related to a gyro sensor can be expressed as (scale factor)=(measured angular velocity)/(true angular velocity). For that reason, when the scale factor related to a gyro sensor is equal to 1.0, it can be defined to be the state having no error.

However, in an actual gyro sensor, as illustrated in FIG. 8, there is an error between the true angular velocity and the measured angular velocity, and it is common that the scale factor deviates from 1.0. Hence, at the time of rotation of the information processing terminal 10, there occurs a rotation amount error. For example, when the scale factor is equal to 0.95, if the information processing terminal 10 is rotated by 90°, the measured angular velocity of 85.5° is obtained and there occurs an error of −4.5° with respect to the true angular velocity.

FIG. 9 is a diagram for explaining the scale factor related to an acceleration sensor. The scale factor related to an acceleration sensor represents the property which, under the premise that the other sensor properties such as the bias characteristics are ideal, indicates the ratio of the true angular velocity with respect to the measured angular velocity along the detection axis. That is, the scale factor related to an acceleration sensor can be expressed as (scale factor)=(measured angular velocity)/(true angular velocity). Thus, in an identical manner to the case of the gyro sensor, the scale factor equal to 1.0 can be defined to be the state having no error.

However, as illustrated in FIG. 9, when an error has occurred between the true acceleration and the measured acceleration, an error occurs also in the velocity and the position obtained as a result of inertial navigation. For example, if there is an acceleration 1.0 m/s/s when the scale factor is equal to 0.95, the measured acceleration is equal to 9.5 m/s/s thereby resulting in the error of 0.05 m/s/s. In this example, in 10 seconds, the velocity error becomes equal to 0.5 m/s and the position error becomes equal to 2.5 m.

In this way, the scale factor related to an inertial sensor can be said to be one of the important sensor properties that affect the measured value. Hence, the evaluating unit 210 according to the present embodiment performs relative evaluation of the scale factor attributed to a plurality of inertial sensors, and the control unit 220 can perform control based on that evaluation.

FIG. 10 is a diagram for explaining the relative evaluation of the scale factor according to the present embodiment. In FIG. 10, the true route actually walked by the user is illustrated along with four other routes calculated from the sensor information collected by the inertial sensors 1 to 4 included in the information processing terminal 10. Moreover, in the example illustrated in FIG. 10, it is assumed that the other sensor properties such as the bias characteristics are ideal.

As a result of comparing the four routes, it can be understood that only the route attributed to the inertial sensor 4 has significantly deviated from the other three routes. Thus, the evaluating unit 210 according to the present embodiment can evaluate that, as compared to the inertial sensors 1 to 3, the inertial sensor 4 has a greater error in the scale factor, that is, has greater divergence; and can set low priority for the inertial sensor 4. In that case, by setting low synthesizing emphasis for the sensor information collected by the inertial sensor 4, the control unit 220 can obtain the PDR locus having high accuracy.

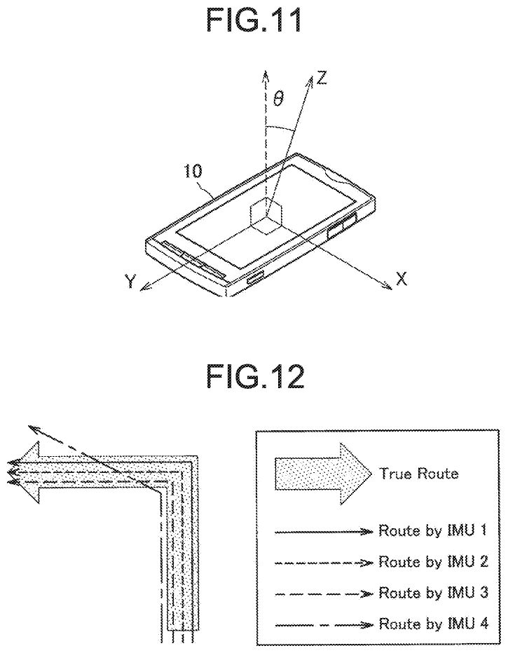

Meanwhile, the evaluating unit 210 according to the present embodiment can perform relative evaluation also of the axial alignment of each inertial sensor. FIG. 11 is a diagram for explaining the axial alignment of the inertial sensor. Essentially, the three axes, namely, the X-axis, the Y-axis, and the Z-axis are orthogonal to each other. However, in an actual inertial sensor, there are times when misalignment occurs as illustrated in FIG. 11. In FIG. 11 is illustrated an example in which the Z axis is misaligned by an angle θ from the right angle.

The axial alignment according to the present embodiment represents the property related to the misalignment of the three axes. That property can be expressed either as an alignment correction matrix with respect to acceleration as given below in Equation (5), or as an alignment correction matrix with respect to gyro as given below in Equation (6).

$$\begin{matrix}{T}^{a} = [ \begin{matrix}1 & - {α}_{yz} & {α}_{zy} \\ 0 & 1 & - {α}_{zx} \\ 0 & 0 & 1\end{matrix} ] & ( 5 ) \\ {T}^{g} = [ \begin{matrix}1 & - {γ}_{yz} & {γ}_{zy} \\ {γ}_{xz} & 1 & - {γ}_{zx} \\ - {γ}_{xy} & {γ}_{yx} & 1\end{matrix} ] & ( 6 )\end{matrix}$$

The post-correction three-axis vector can be expressed as (alignment correction matrix)×(pre-correction measurement value three vector), with all diagonal elements becoming equal to zero and the state of no alignment error being attained. Meanwhile, it is common practice by which, before the shipment from the factory, the terminal is kept stationary in various attitudes using a device, and each parameter is measured along with the scale factor and the bias.

Meanwhile, although it becomes complex in the case of handling all of the three-axis elements; in the case of handling only a single axis, the rate of change (the rate of measurement) can be set to be equal to cos θ, so that the measurement value can be expressed as (measurement value)=(rate of measurement)×(true measurement value). For example, when θ=5° holds true, the rate of measurement becomes equal to 0.996 times. In that case, if the information processing terminal 10 is rotated by 90°, the measurement angular velocity of 89.64° is obtained, and there occurs an error of −0.36° with respect to the true angular velocity.

In this way, the axial alignment related to an inertial sensor can be said to be one of the important sensor properties that affect the measured value. Hence, the evaluating unit 210 according to the present embodiment performs relative evaluation of the axial alignment attributed to a plurality of inertial sensors, and the control unit 220 can perform control based on that evaluation.

FIG. 12 is a diagram for explaining the relative evaluation of axial alignment according to the present embodiment. In FIG. 12, the true route actually walked by the user is illustrated along with four other routes calculated from the sensor information collected by the inertial sensors 1 to 4 included in the information processing terminal 10. Moreover, in the example illustrated in FIG. 12, it is assumed that the other sensor properties such as the bias characteristics are ideal.

As a result of comparing the four routes, it can be understood that only the route attributed to the inertial sensor 4 has significantly deviated from the other three routes. Thus, the evaluating unit 210 according to the present embodiment can evaluate that, as compared to the inertial sensors 1 to 3, the inertial sensor 4 has a greater error of the axial alignment, that is, has greater divergence; and can set low priority for the inertial sensor 4. In that case, by setting low synthesizing emphasis for the sensor information collected by the inertial sensor 4, the control unit 220 can obtain the PDR locus having high accuracy.

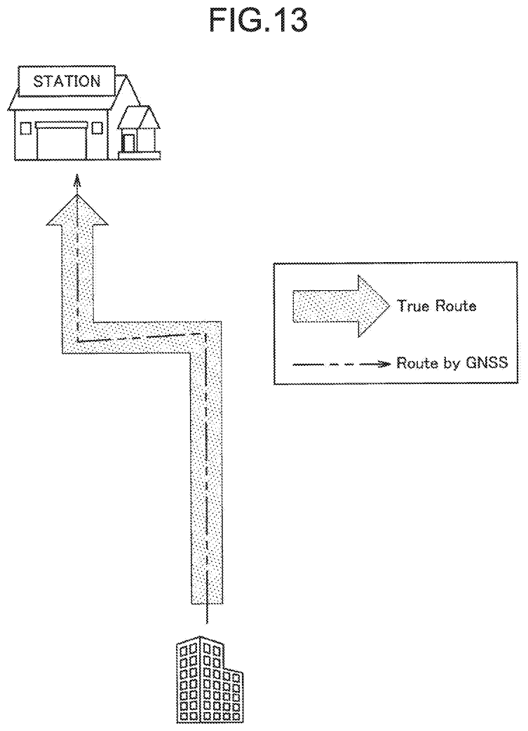

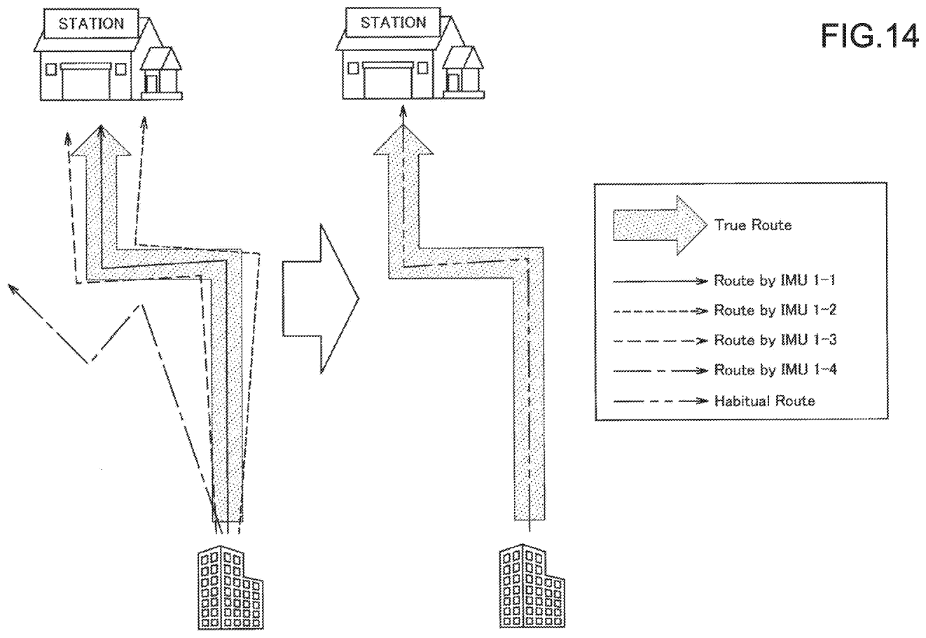

Given below is the explanation of relative evaluation performed based on the habitual route according to the present embodiment. FIG. 13 is a diagram for explaining the habitual route according to the present embodiment. For example, as illustrated in FIG. 13, when the GNSS reception environment is excellent between the office and the closest station and when it is possible to habitually obtain similar GNSS loci, the evaluating unit 210 according to the present embodiment can perform evaluation of each inertial sensor with the GNSS locus serving as the habitual route.

For example, the evaluating unit 210 can calculate the divergence between the habitual route and the PDR locus of each inertial sensor, and can set the priority according to the divergence. As a result of using the abovementioned functions of the evaluating unit 210 according to the present embodiment, relative evaluation of the properties of a plurality of inertial sensors can be performed based on habituation, and appropriate input-output control can be performed based on that evaluation.

Examples of the criterion for determining that the GNSS locus implies the identical route include the closeness of the positions (such as a small sum of squared differences at each position of the locus), the time slot of the commute time, and the shape of the locus. Moreover, for example, the habitual route according to the present embodiment can be used in common by a plurality of users working at the same office.

Meanwhile, the evaluating unit 210 according to the present embodiment can obtain the average of a plurality of PDR loci as the habitual route. In FIG. 14 is illustrated an example of the habitual route that is based on a plurality of PDR loci according to the present embodiment. The variability attributed to the directivity of the gyro bias is known to be a Gaussian distribution. Hence, the bias of the angle values (attitude/azimuth), which are obtained as a result of integrating the gyro values (angular velocity), can also be said to follow a Gaussian distribution. That is, when the PDR relative loci (using azimuth values) obtained for a plurality of number of times in the same walking route are synthesized, it is believed that the result converges to the true route.

Hence, for example, as illustrated in FIG. 14, the evaluating unit 210 according to the present embodiment can obtain the habitual route by taking average synthesis of the PDR loci for a plurality of number of times related to the same inertial sensor. At that time, the evaluating unit 210 can select the PDR loci, which are to be used in synthesis, based on the time slot, the locus length, and the closeness of the positions obtained using the GNSS or Wi-Fi. Alternatively, the evaluating unit 210 according to the present embodiment can obtain the habitual route by synthesizing the PDR loci attributed to a plurality of inertial sensors.

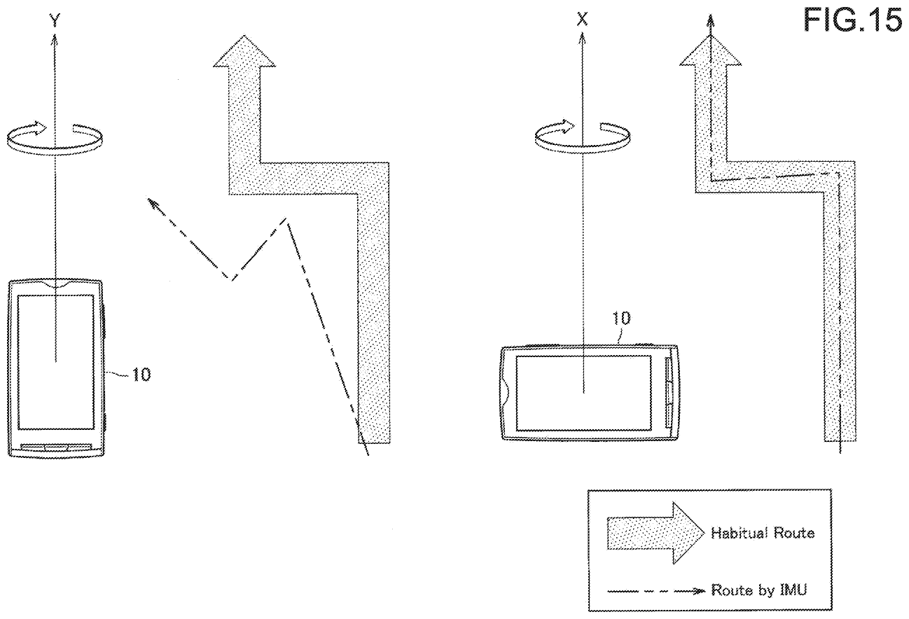

Moreover, based on the habitual route obtained in the manner described above, the evaluating unit 210 according to the present embodiment can generate evaluation information for each three-axis attitude of the information processing terminal. FIG. 15 is a diagram for explaining the evaluation information for each three-axis attitude according to the present embodiment. In the left-hand side in FIG. 15 is illustrated the comparison between the habitual route and the PDR locus obtained when the Y-axis of the information processing terminal 10 is oriented upward; and in the right-hand side in FIG. 15 is illustrated the comparison between the habitual route and the PDR locus obtained when the X-axis of the information processing terminal 10 is oriented upward.

In this case, even when the same inertial sensor is used (or when the same combination of inertial sensors is used), the evaluating unit 210 according to the present embodiment can set higher level of evaluation when the Y-axis is oriented upward. Then, based on the evaluation, the control unit 220 according to the present embodiment can perform application control corresponding to the three-axis attitude of the information processing terminal 10.

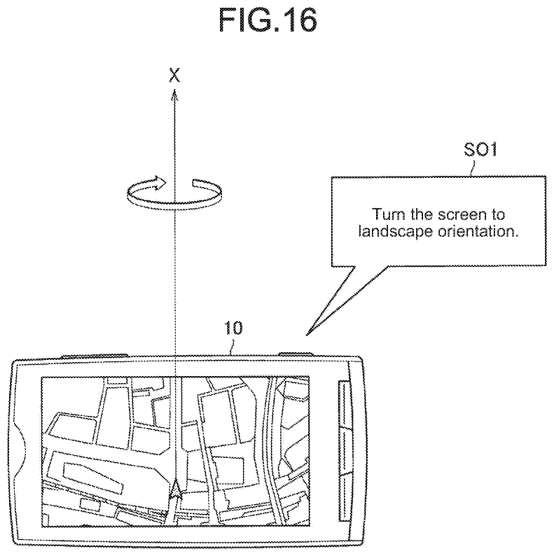

FIG. 16 is a diagram illustrating an example of application control performed based on the evaluation of each three-axis attitude according to the present embodiment. For example, if the evaluating unit 210 evaluates that the case of having the X-axis of the information processing terminal 10 oriented upward has a higher accuracy as compared to the case of having the Y-axis oriented upward, then the control unit 220 can control the application display suitable to the X-axis having the higher level of evaluation. Moreover, at that time, for example, the control unit 220 can output, to the information processing terminal 10, a system utterance SO1 meant for guiding the user to the abovementioned display.

In this way, based on the evaluation information for each three-axis attitude as generated by the evaluating unit 210, the control unit 220 according to the present embodiment can control the behavior of the applications in which the sensor information is used. As a result of using the functions of the control unit 220 according to the present embodiment, based on the properties of the inertial sensors for each three-axis attitude, the user can be provided with functions having higher accuracy.

Meanwhile, with reference to FIG. 16, the explanation is given about a case in which the control unit 220 controls the behavior of the applications based on the evaluation information of each three-axis attitude. Alternatively, the control unit 220 according to the present embodiment can vary the arrangement directions of the inertial sensors based on the evaluation information.

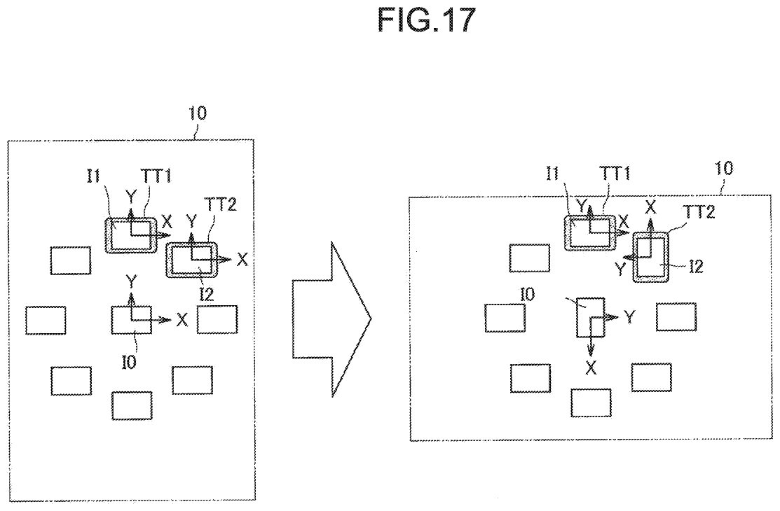

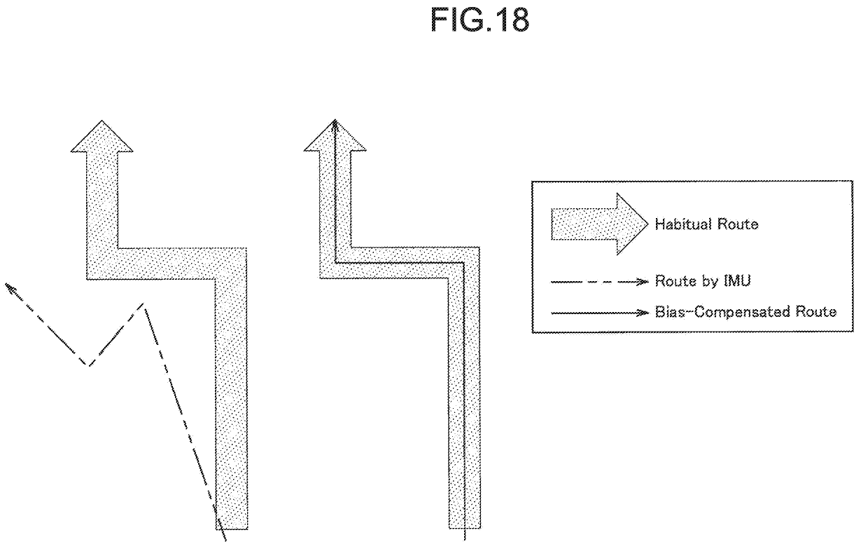

FIG. 17 is a diagram for explaining the arrangement control of the inertial sensors according to the present embodiment. In FIG. 17 is illustrated an example in which a plurality of inertial sensors, including inertial sensors I0 and I1, is arranged. In the left-hand side in FIG. 17, an example of the initial arrangement is illustrated when the Y-axis of the information processing terminal 10 is oriented upward. The inertial sensor I0 can be an inertial sensor for determining the azimuth (detecting the direction of gravitational force) of the information processing terminal 10, and eight inertial sensors including inertial sensors I1 and I2 are arranged at equal intervals around the inertial sensor I0.

In each of the inertial sensors including the inertial sensors I1 and I2, a turntable is placed at the base portion. In FIG. 17, although only turntables TT1 and TT2 placed at the base portions of the inertial sensors I1 and I2, respectively, are illustrated, the turntable according to the present embodiment can be placed at the base portion of each other inertial sensor in an identical manner.

At that time, the control unit 220 according to the present embodiment rotates each turntable based on the evaluation information of each three-axis attitude generated by the evaluating unit 210, and can thus control the arrangement direction of each sensor.

For example, in the example illustrated in FIG. 17, based on the fact that the evaluating unit 210 evaluated the inertial sensor I1 having the Y-axis oriented upward to be of excellent accuracy, even in the case in which information processing terminal 10 is held in the landscape orientation, the control unit 220 can rotate the turn table TT1 in such a way that the Y-axis is oriented upward.

In an identical manner, based on the fact that the evaluating unit 210 evaluated the inertial sensor I2 having the X-axis oriented upward to be of excellent accuracy, even in the case in which information processing terminal 10 is held in the landscape orientation, the control unit 220 can rotate the turn table TT2 in such a way that the X-axis is oriented upward.

In this way, as a result of using the control unit 220 according to the present embodiment, based on the evaluation information, the turn tables are rotated so as to vary the physical arrangement directions of the inertial sensors in such a way that the azimuth of higher accuracy can be calculated. Because of the functions of the control unit 220 according to the present embodiment, regardless of the attitude of the information processing terminal 10, it becomes possible to invariably perform azimuth detection of high accuracy. Meanwhile, in FIG. 17 is illustrated an example in which the turn table is placed for each inertial sensor according to the present embodiment. Alternatively, it is also possible that only a single turn table is placed for a plurality of inertial sensors according to the present embodiment.

Till now, the explanation was given about an example of the evaluation and the control of the inertial sensors based on the habitual route according to the present embodiment. Besides the example explained above, the information processing server 20 according to the present embodiment can also perform a variety of other control based on the habitual route.

For example, the control unit 220 according to the present embodiment can perform bias compensation of the inertial sensors based on the habitual route obtained by the evaluating unit 210. FIG. 18 is a diagram for explaining the bias compensation performed based on the habitual route according to the present embodiment.

In the left-hand side in FIG. 18, the habitual route obtained by the evaluating unit 210 is illustrated along with the PDR locus of a particular inertial sensor. When a PDR locus is observed to deviate from the habitual route, the control unit 220 according to the present embodiment can perform correction in order to optimize the bias in such a way that the deviated PDR route converges to the habitual route. If such correction is implemented on the inertial sensors having low accuracy, it is expected to prove particularly effective. Moreover, as a result of the correction performed by the control unit 220, when the optimum bias obtained by correction is used thereafter, high-accuracy position calculation can be performed even for the locations for which the habitual route has not been obtained.

The explanation above is given about an example in which the evaluating unit 210 obtains the habitual route based on the GNSS locus or based on the PDR loci for a plurality of number of times. Alternatively, the evaluating unit 210 according to the present embodiment can obtain the habitual route based on the user input.

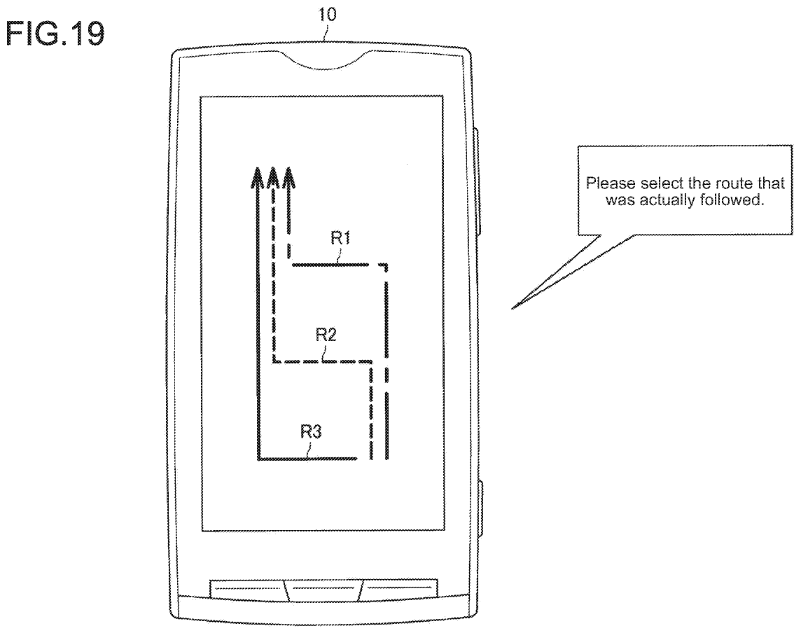

FIG. 19 is a diagram for explaining about obtaining the habitual route based on the user input according to the present embodiment. In FIG. 19 are illustrated candidates R1 to R3 of the habitual route that are displayed in the information processing terminal 10. In this way, for example, the evaluating unit 210 can obtain the habitual route based on the route selected by the user from among a plurality of presented candidates. Meanwhile, the user input is not limited to the selection from a plurality of candidates, and can be substituted with directly drawing the route on a map.

Given below is the explanation about the evaluation performed based on the reference performance of the inertial sensors according to the present embodiment, and the explanation about the control performed based on that evaluation. The explanation above was given mainly about the case in which the evaluating unit 210 performs relative evaluation of a plurality of inertial sensors having the same reference performance.

On the other hand, the information processing terminal 10 can include a plurality of inertial sensors having different reference performances. For example, in recent years, inertial sensors having the A/D resolution of 16 bits are being widely used. However, in the case of the same bit count, there is a trade-off between the scope of the measurement range and the level of resolution. For that reason, whether to give priority to the measurement range or the resolution can be decided according to the end usage of the sensor information collected by the inertial sensors.

For example, when it is possible to think of high-speed rotation (angular velocity) or high impact (acceleration) of the information processing terminal 10, it is desirable to use the inertial sensors having a broad measurement range. On the other hand, when the operations are slow but high accuracy is demanded, it is suitable to use the inertial sensors having high resolution.

Thus, the control unit 220 according to the present embodiment can dynamically perform control regarding the input-output of the sensor information based on the end usage of the sensor information and the reference performances of the inertial sensors.

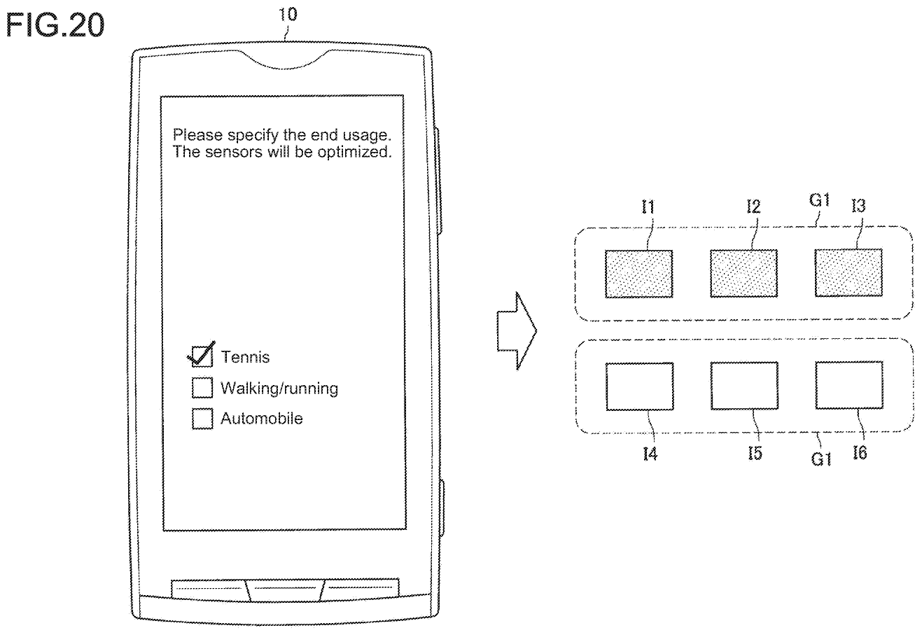

FIGS. 20 to 22 are diagrams for explaining the selection of inertial sensors based on the reference performances according to the present embodiment. For example, in the left-hand side in FIG. 20, a user interface is illustrated that is meant for enabling the user to select the end usage. For example, assume that the user selects an end usage, such as “tennis”, that involves high-speed rotation (angular velocity) and high impact (acceleration). In that case, the control unit 220 according to the present embodiment can select the inertial sensors that satisfy the reference performance appropriate for the reference performance “tennis”.

For example, as illustrated in FIG. 20, assume that the information processing terminal 10 includes the inertial sensors I1 to I3 belonging to a group G1 and includes the inertial sensors I4 to I6 belonging to a group G2. The group G1 can be a group made of inertial sensors having a broad measurement range, and the group G2 can be a group made of inertial sensors having a high resolution.

Based on the end usage “tennis” selected by the user, the control unit 220 can select the inertial sensors I1 to I3 belonging to the group G1. In this way, the control unit 220 according to the present embodiment enables selection of such inertial sensors which have the appropriate reference performance in accordance with the end usage of the sensor information.

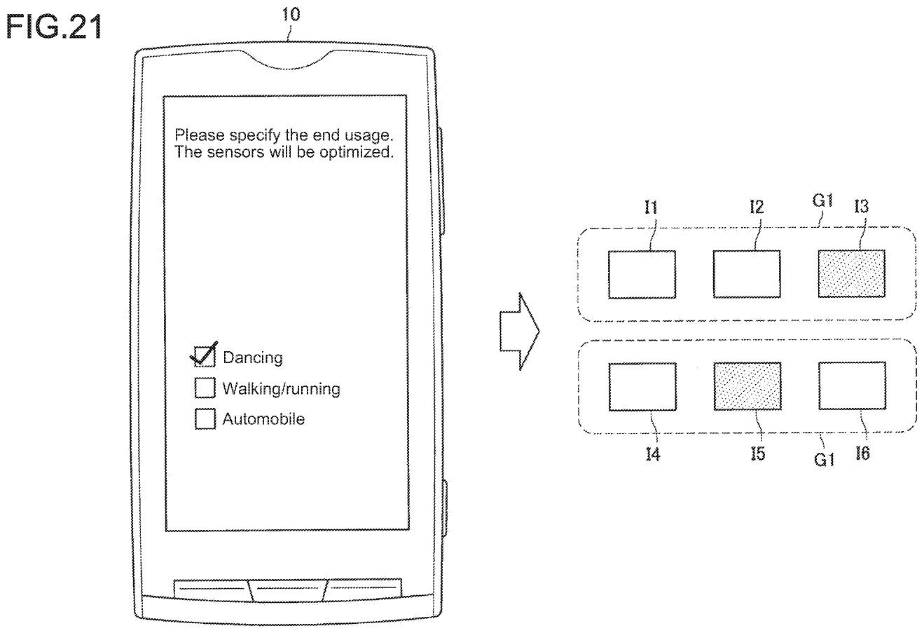

In FIG. 21 is illustrated an example in which the user selects an end usage “dancing”. Generally, sports such as “dancing” demand following speedy movements with high accuracy. In such a case, the control unit 220 according to the present embodiment can select one or more inertial sensors from the group G1 having a broad measurement range and the group G2 having a high resolution. In that case, the control unit 220 can firstly perform measurement in a broad range. Then, if the collected data indicates values exceeding a narrow range, the control unit 220 can perform control to keep using the values for the broad range. On the other hand, if the collected data indicates values within the narrow range, the control unit 220 can perform control to use high-resolution values.

In the example illustrated in FIG. 21, the control unit 220 selects the inertial sensor I3 from the group G1 having a broad measurement range, and selects the inertial sensor 15 from the group G2 having a high resolution. Herein, based on the evaluation information generated by the evaluating unit 210 and illustrated in Table 2 given below, the control unit 220 according to the present embodiment can select only the inertial sensor having the best accuracy from each group. Moreover, the control unit 220 can switch off the power supply to the unselected inertial sensors so as to reduce the power consumption in an effective manner.

TABLE 2

| Inertial sensor # | 1 | 2 | 3 | 4 | 5 | 6 |
|---|---|---|---|---|---|---|
| Bias instability [dph] | 10 | 20 | 5 | 10 | 5 | 20 |

With reference to FIGS. 20 and 21, an example is explained in which the control unit 220 selects the inertial sensors based on the measurement range and the resolution. In addition, the reference performance according to the present embodiment can also include the compatible frequency range. Usually, an inertial sensor has a filter embedded therein for enabling selection of the compatible frequency range. Generally, an inertial sensor dedicated to a narrow area can deal only with slow movements, but tends to have a small noise. On the other hand, an inertial sensor compatible to a broad area can follow fast movements, but has a large noise.

Hence, the control unit 220 according to the present embodiment can select the inertial sensors, which are to be used, in such a way that the band frequency appropriate for the end usage is achieved. At that time, for example, based on the evaluation information illustrated in Table 3 given below, the control unit 220 can select the inertial sensors appropriate for the end usage. For example, when the end usage is a sport such as “jogging”, it becomes important to have a broad measurement range and a broad frequency range even if the resolution is coarse. In that case, the control unit 220 can select an inertial sensor 2 based on the evaluation information illustrated in Table 3.

TABLE 3

| Inertial sensor # | 1 | 2 | 3 | 4 |
|---|---|---|---|---|
| Resolution [dps/LSB] | 0.03 | 0.3 | 0.012 | 0.006 |
| Measurement range [dps] | 100 | 1000 | 400 | 200 |
| Frequency range [Hz] | 50 | 300 | 200 | 150 |

The explanation above is given about the case in which, based on the end usage selected by the user, the control unit 220 selects the inertial sensors satisfying the reference performance appropriate for the end usage. Alternatively, the control unit 220 according to the present embodiment can be configured to automatically select the inertial sensors based on the application that is run.

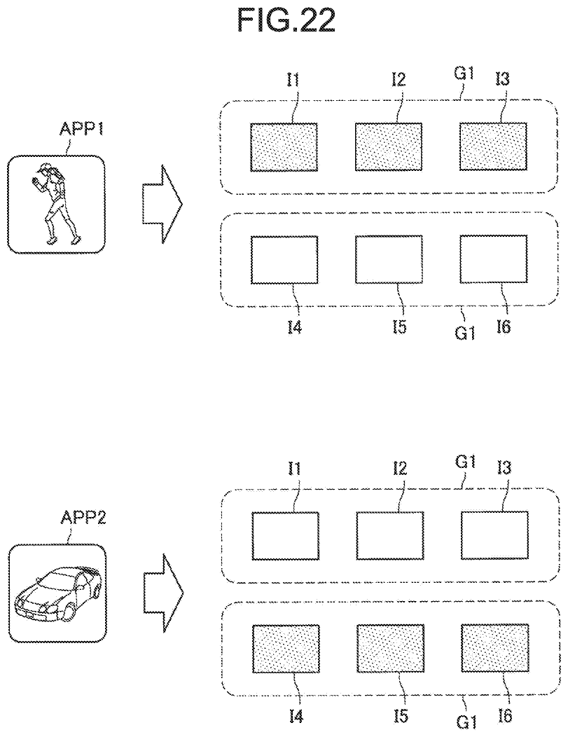

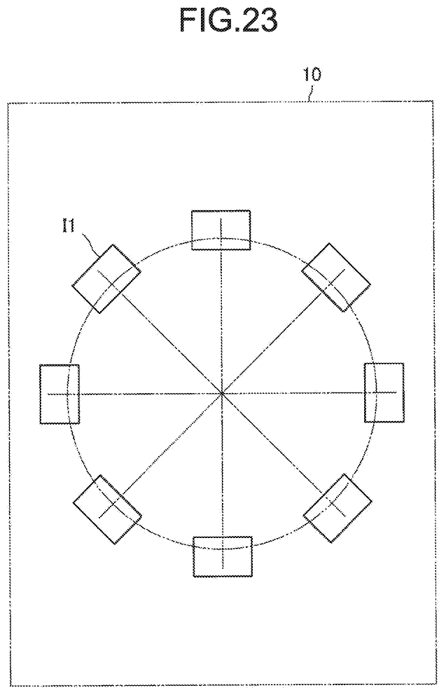

FIG. 22 is a diagram for explaining the selection of inertial sensors based on an application according to the present embodiment. For example, in the upper part of FIG. 22, an example is illustrated in which an application APP1 related to “jogging” is run. In that case, the control unit 220 can select the inertial sensor I1 to I3 belonging to the group G1 for a broad measurement range appropriate for “jogging”.

In the lower part of FIG. 22, an example is illustrated in which an application APP2 related to “car navigation” is run. In that case, the control unit 220 can select the inertial sensors I4 to I6 belonging to the group G2 for a high resolution appropriate for “car navigation”.

In this way, based on the application in which the sensor information is used, the control unit 220 according to the present embodiment can dynamically decide on the inertial sensors to be used. Moreover, for example, on the basis of the action recognition by the user based on image information or other sensor information, the control unit 220 can select the inertial sensors appropriate for the recognized action. As a result of using the functions of the control unit 220 according to the present embodiment, the inertial sensors appropriate for the end usage can be selected in a dynamic manner, thereby making it possible to follow the actions with high accuracy.

Till now, detailed explanation was given about the functions of the information processing server 20 according to the present embodiment. As described above, the information processing server 20 according to the present embodiment enables performing relative evaluation of the properties of a plurality of inertial sensors and performing appropriate control based on the evaluation.

Meanwhile, the technical idea according to the present embodiment is not limited to the examples described above, and can be implemented as various technologies for absorbing the individual differences in the properties of the inertial sensors. For example, in the information processing terminal 10 according to the present embodiment, a plurality of inertial sensors can be arranged in different directions so that the variability in the inter-axis properties can be reduced.

FIG. 23 is a diagram for explaining the multidirectional arrangement of the inertial sensors according to the present embodiment. In FIG. 23 is illustrated an example in which eight inertial sensors are arranged in different directions but at equal intervals in the information processing terminal 10.

In the multidirectional arrangement illustrated in FIG. 23, even when there is variability in the inter-axis properties of a plurality of inertial sensors, it is possible to absorb the overall variability and to perform azimuth detection of high accuracy. The multidirectional arrangement according to the present embodiment is particularly effective in a terminal such as a smartphone whose orientation is changed on a frequent basis.

The explanation above was given mainly about an example in which the information processing server 20 according to the present embodiment controls the input-output of the inertial sensors installed in the information processing terminal 10 such as a smartphone. However, the target for control by the information processing server 20 according to the present embodiment is not limited to that example. Alternatively, for example, the information processing server 20 according to the present embodiment can perform remote control of the inertial sensors installed in an artificial satellite.

In recent years, inertial sensors are being used also in attitude control and locus estimation of artificial satellites, and it is not rare to have cases in which economical inertial sensors of the mechanical type are used in plurality instead of costly inertial sensors of the optical type. In such cases, in an identical manner to the case of a smartphone, the information processing server 20 according to the present embodiment can perform remote control of the inertial sensors installed in the information processing terminal 10 representing an artificial satellite.

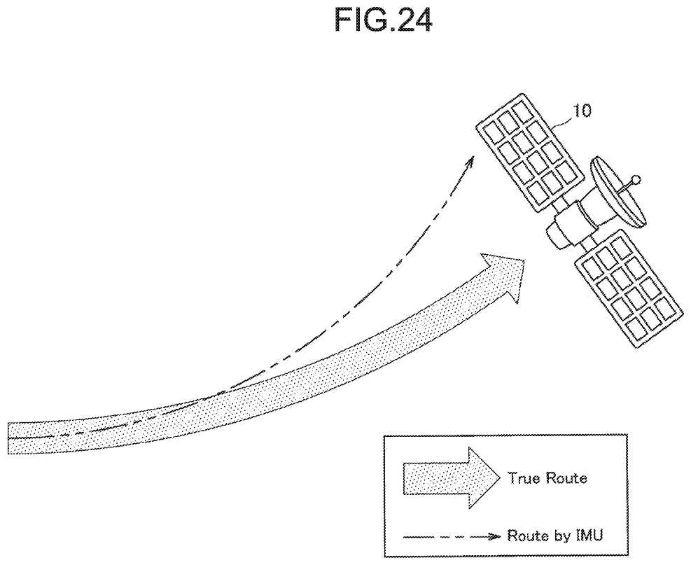

FIG. 24 is a diagram for explaining the remote control performed with respect to the inertial sensors installed in an artificial satellite according to the present embodiment. In FIG. 24, the true orbit of the information processing terminal 10 representing an artificial satellite is illustrated along with the orbit obtained by a plurality of sensors installed in the information processing terminal 10.

As described above, since the bias characteristics of the inertial sensors change in a dynamic manner; if the remote control is not performed, it is also possible to think of a case in which the orbit obtained by the inertial sensors significantly deviates from the true orbit as illustrated in FIG. 24.

In order to avoid such a situation from occurring, the information processing server 20 according to the present embodiment can perform relative evaluation of the bias characteristics of a plurality of inertial sensors installed in the information processing terminal 10 representing an artificial satellite; identify the inertial sensors having a decline in accuracy thereby likely causing the deviation; and stop those inertial sensors in a remote manner. In this way, the technical idea according to the present embodiment can be implemented in a broad sense in various devices in which a plurality of inertial sensors is installed.

### 2. Hardware Configuration Example

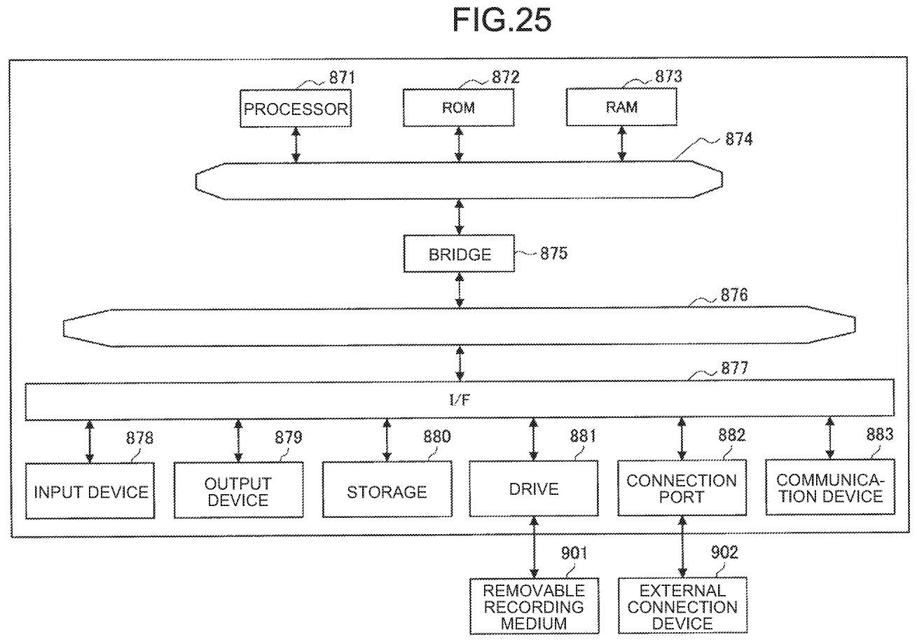

Given below is the explanation of a hardware configuration example used in common in the information processing terminal 10 and the information processing server 20 according to the embodiment of the application concerned. FIG. 25 is a block diagram of a hardware configuration example of the information processing terminal 10 and the information processing server 20 according to the embodiment of the application concerned. With reference to FIG. 25, the information processing terminal 10 as well as the information processing server 20 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Meanwhile, this hardware configuration is only exemplary, and some of the constituent elements can be omitted. On the other hand, apart from the constituent elements mentioned above, some other constituent elements can also be included.

(Processor 871)

The processor 871 functions as, for example, an arithmetic processing device or a control device; and controls the operations, entirely or partially, of the constituent elements based on various programs recorded in the ROM 872, the RAM 873, the storage 880, or a removable recording medium 901.

(ROM 872 and RAM 873)

The ROM 872 is used to store programs to be read by the processor 871, and to store the data to be used in arithmetic processing. In the RAM 873, for example, programs to be read by the processor 871 are stored, either temporarily or permanently, along with various parameters that undergo changes during the execution of the programs.

(Host Bus 874, Bridge 875, External Bus 876, Interface 877)

The processor 871, the ROM 872, and the RAM 873 are connected to each other by, for example, the host bus 874 that is capable of high-speed data transmission. Moreover, for example, the host bus 874 is connected to the external bus 876, which has a relatively low data transmission speed, via the bridge 875. Furthermore, the external bus 876 is connected to various constituent elements via the interface 877.

(Input Device 878)

In the input device 878, for example, a mouse, a keyboard, a touch-sensitive panel, buttons, switches, and levers are used. Alternatively, as the input device 878, it is also possible to use a remote controller capable of transmitting control signals using infrared light or some other type of radio waves. Moreover, in the input device 878, a sound input device such as a microphone can be included.

(Output Device 879)

The output device 879 is a device, such as a display device such as a CRT (Cathode Ray Tube), an LCD, or an organic EL; or an audio output device such as a speaker or headphones; or a printer; or a cellular phone; or a facsimile machine, that is capable of notifying the user, visually or aurally, about the obtained information. Moreover, the output device 879 according to the application concerned includes one of various vibration devices capable of outputting tactile stimulation.

(Storage 880)

The storage 880 is a device for storing a variety of data. As the storage 880, for example, a magnetic memory device such as a hard disk drive (HDD) is used; or a semiconductor memory device is used; an optical memory device is used; or a magneto-optical memory device is used.

(Drive 881)

The drive 881 is a device, such as a magnetic disk, an optical disk, a magneto-optical disk, or a semiconductor memory, that is used for reading information recorded in the removable recording medium 901 or for writing information in the removable recording medium 901.

(Removable Recording Medium 901)

The removable recording medium 901 is, for example, a DVD media, a Blu-ray (registered trademark) media, an HD DVD media, or one of various semiconductor memory media. Of course, the removable recording medium 901 can be, for example, an IC card having a contactless IC chip installed therein; or an electronic device.

(Connection Port 882)

The connection port 882 is a port, such as a USB (Universal Serial Bus) port, an IEEE1394 port, an SCSI (Small Computer System Interface), an RS-232C port, or an audio terminal, that is meant for establishing connection with an external connection device 902.

(External Connection Device 902)

The external connection device 902 is, for example, a printer, a portable music player, a digital camera, a digital video camera, or an IC recorder.

(Communication Device 883)

The communication device 883 is a communication device for establishing connection with a network and is, for example, a communication card for a wired or a wireless LAN, Bluetooth (registered trademark), or WUSB (Wireless USB); or is a router for optical communication; or is a router for ADSL (Asymmetric Digital Subscriber Line); or one of various communication modems.

### 3. Summary

As described above, the information processing server 20 according to the embodiment of the application concerned includes an evaluating unit that, based on sensor information coming from a plurality of inertial sensors, performs relative evaluation of the sensor properties of the inertial sensors; and a control unit that, based on evaluation information generated by the evaluating unit, dynamically performs control related to the input-output of the sensor information. With such a configuration, it becomes possible to implement flexible and highly accurate function control according to the properties of each of a plurality of sensors.

Although the application concerned is described above in detail in the form of a preferred embodiment with reference to the accompanying drawings; the technical scope of the application concerned is not limited to the embodiment described above. That is, the application concerned is to be construed as embodying all modifications such as other embodiments, additions, alternative constructions, and deletions that may occur to one skilled in the art that fairly fall within the basic teaching herein set forth.

Moreover, the effects described in the present written description are only explanatory and exemplary, and are not limited in scope. That is, in addition to or in place of the effects described above, the technology disclosed in the application concerned enables achieving other effects that may occur to one skilled in the art.

Meanwhile, it is also possible to create a program for making the hardware of a computer including a CPU, a ROM, and a RAM implement functions equivalent to the configuration of the information processing server 20; and it is possible to provide a computer-readable recording medium in which that program is recorded.

Meanwhile, the steps of the operations performed by the information processing server 20 in the present written description need not necessarily be processed chronologically according to the order given in sequence diagrams and flowcharts. For example, the steps of the operations performed by the information processing server 20 can be processed in a different order than the order given in flowcharts, or can be processed in parallel.

Meanwhile, a configuration as explained below also falls within the technical scope of the application concerned.

(1)

An information processing device comprising:
an evaluation unit that, based on sensor information coming from a plurality of inertial sensors, performs relative evaluation of sensor property of the plurality of inertial sensors; and
a control unit that, based on evaluation information generated by the evaluating unit, performs dynamic control related to input-output of the sensor information.
   (2)

The information processing device according to (1), wherein the sensor property includes at least either bias characteristics, or scale factor, or axial alignment.

(3)

The information processing device according to (1) or (2), wherein, based on the evaluation information, the control unit controls synthesis of the sensor information coming from the plurality of inertial sensors.

(4)

The information processing device according to (3), wherein, based on the evaluation information, the control unit dynamically decides on emphasis of the plurality of inertial sensors during synthesis of the sensor information.

(5)

The information processing device according to (4), wherein
the evaluation unit generates evaluation information containing priority of the plurality of inertial sensors, and
the control unit dynamically decides on the emphasis based on the priority.
   (6)

The information processing device according to (5), wherein the evaluating unit sets the priority based on divergence between weighted average of the sensor information coming from the plurality of inertial sensors and the sensor information coming from the inertial sensor to be evaluated.

(7)

The information processing device according to (6), wherein the evaluating unit calculates the divergence for each of a plurality of combinations of the plurality of inertial sensors, and sets high priority for the inertial sensor not included in the combination having the divergence to be maximum.

(8)

The information processing device according to any one of (3) to (7), wherein, based on the evaluation information, the control unit decides on the inertial sensors to be used during synthesis of the sensor information.

(9)

The information processing device according to any one of (1) to (8), wherein, based on end usage of the sensor information and based on reference performance of the inertial sensors, the control unit performs dynamic control related to input-output of sensor information.

(10)

The information processing device according to (9), wherein the reference performance includes at least either measurement range, or resolution, or compatible frequency range.

(11)

The information processing device according to (9) or (10), wherein, based on application in which the sensor information is used and based on the reference performance, the control unit decides on the inertial sensors to be used.

(12)

The information processing device according to any one of (1) to (11), wherein, based on the evaluation information, the control unit controls activation and deactivation of the inertial sensors.

(13)

The information processing device according to any one of (1) to (12), wherein the evaluating unit compares obtained habitual route with locus obtained from the sensor information collected by the inertial sensor to be evaluated, and generates the evaluation information.

(14)

The information processing device according to (13), wherein the evaluating unit generates the evaluation information for each three-axis attitude of a terminal that includes the plurality of inertial sensors.

(15)

The information processing device according to (14), wherein, based on the evaluation information for each of the three-axis attitude, the control unit controls behavior of application in which the sensor information is used.

(16)

The information processing device according to (15), wherein the control unit controls display of the application in a suitable manner to axis having highest evaluation from among the three-axis attitudes.

(17)

The information processing device according to any one of (14) to (16), wherein, based on the evaluation information for each of the three-axis attitude, the control unit varies arrangement direction of the inertial sensors.

(18)

The information processing device according to any one of (1) to (17), further comprising a synthesizing unit that, based on control performed by the control unit, synthesizes sensor information coming from the plurality of inertial sensors.

(19)

The information processing device according to any one of (1) to (18), further comprising the plurality of inertial sensors.

(20)

An information processing method implemented in a processor, comprising:
evaluating that, based on sensor information coming from a plurality of inertial sensors, includes performing relative evaluation of sensor property of the plurality of inertial sensors; and
controlling that, based on generated evaluation information, includes performing dynamic control related to input-output of the sensor information.
   (21)

A program that causes a computer to function as an information processing device including
an evaluation unit that, based on sensor information coming from a plurality of inertial sensors, performs relative evaluation of sensor property of the plurality of inertial sensors, and
a control unit that, based on evaluation information generated by the evaluating unit, performs dynamic control related to input-output of the sensor information.

### REFERENCE SIGNS LIST

10 information terminal
110 sensor unit
120 input unit
130 output unit
140 control unit
150 communication unit
20 information processing server
210 evaluating unit
220 control unit
230 synthesizing unit
240 terminal communication unit
30 sensor terminal

1. An information processing device comprising:
an evaluation unit that, based on sensor information coming from a plurality of inertial sensors, performs relative evaluation of sensor property of the plurality of inertial sensors; and
a control unit that, based on evaluation information generated by the evaluating unit, performs dynamic control related to input-output of the sensor information.

2. The information processing device according to claim 1, wherein the sensor property includes at least either bias characteristics, or scale factor, or axial alignment.

3. The information processing device according to claim 1, wherein, based on the evaluation information, the control unit controls synthesis of the sensor information coming from the plurality of inertial sensors.

4. The information processing device according to claim 3, wherein, based on the evaluation information, the control unit dynamically decides on emphasis of the plurality of inertial sensors during synthesis of the sensor information.

5. The information processing device according to claim 4, wherein
the evaluation unit generates evaluation information containing priority of the plurality of inertial sensors, and
the control unit dynamically decides on the emphasis based on the priority.

6. The information processing device according to claim 5, wherein the evaluating unit sets the priority based on divergence between weighted average of the sensor information coming from the plurality of inertial sensors and the sensor information coming from the inertial sensor to be evaluated.

7. The information processing device according to claim 6, wherein the evaluating unit calculates the divergence for each of a plurality of combinations of the plurality of inertial sensors, and sets high priority for the inertial sensor not included in the combination having the divergence to be maximum.

8. The information processing device according to claim 3, wherein, based on the evaluation information, the control unit decides on the inertial sensors to be used during synthesis of the sensor information.

9. The information processing device according to claim 1, wherein, based on end usage of the sensor information and based on reference performance of the inertial sensors, the control unit performs dynamic control related to input-output of sensor information.

10. The information processing device according to claim 9, wherein the reference performance includes at least either measurement range, or resolution, or compatible frequency range.

11. The information processing device according to claim 9, wherein, based on application in which the sensor information is used and based on the reference performance, the control unit decides on the inertial sensors to be used.

12. The information processing device according to claim 1, wherein, based on the evaluation information, the control unit controls activation and deactivation of the inertial sensors.

13. The information processing device according to claim 1, wherein the evaluating unit compares obtained habitual route with locus obtained from the sensor information collected by the inertial sensor to be evaluated, and generates the evaluation information.

14. The information processing device according to claim 13, wherein the evaluating unit generates the evaluation information for each three-axis attitude of a terminal that includes the plurality of inertial sensors.

15. The information processing device according to claim 14, wherein, based on the evaluation information for each of the three-axis attitude, the control unit controls behavior of application in which the sensor information is used.

16. The information processing device according to claim 15, wherein the control unit controls display of the application in a suitable manner to axis having highest evaluation from among the three-axis attitudes.

17. The information processing device according to claim 14, wherein, based on the evaluation information for each of the three-axis attitude, the control unit varies arrangement direction of the inertial sensors.

18. The information processing device according to claim 1, further comprising a synthesizing unit that, based on control performed by the control unit, synthesizes sensor information coming from the plurality of inertial sensors.

19. An information processing method implemented in a processor, comprising:
evaluating that, based on sensor information coming from a plurality of inertial sensors, includes performing relative evaluation of sensor property of the plurality of inertial sensors; and
controlling that, based on generated evaluation information, includes performing dynamic control related to input-output of the sensor information.

20. A program that causes a computer to function as an information processing device including
an evaluation unit that, based on sensor information coming from a plurality of inertial sensors, performs relative evaluation of sensor property of the plurality of inertial sensors, and
a control unit that, based on evaluation information generated by the evaluating unit, performs dynamic control related to input-output of the sensor information.
